(19) United States
(12) Patent Application Publication
(10) Pub. No.: US 2006/0227011 A1
(43) Pub. Date: Oct. 12, 2006

(54) SPEED BUMP MOUNTED LICENSE PLATE CAMERA SYSTEM

(76) Inventors: Richard D. Fripp II, Reno, NV (US); Sean L. Fripp, Concord, CA (US)

Correspondence Address: INTELLECTUAL PROPERTY LAW OFFICES, 1901 S. BASCOM AVENUE, SUITE 660, CAMPBELL, CA, 95008, US

(21) Appl. No.: 11/279,467

(22) Filed: Apr. 12, 2006

Related U.S. Application Data
(60) Provisional application No. 60/670,860, filed on Apr. 12, 2005.

(51) Int. Cl. G08G 1/054

(52) U.S. Cl. 340/937

(57) ABSTRACT

A speed bump camera mounting system (10) is provided for capture of photographic images or license places on passing vehicles. The system includes an elongated speed bump (12) for mounting on a driving surface (14). A pair of cameras (46) are mounted in angled image tubes (38) to deliver photographic (video) images to an external control system (18). Visual enhancement elements in the form of reflectors (44) and stripes (42) help a driver to center over the speed bump (20) during travel, thus aligning the license plate with the camera (46).

The following claims priority from a provisional patent application Ser. No. 60/670,860, filed 12 Apr. 2005 by the same inventors.

### TECHNICAL FIELD

The present invention relates generally to traffic control devices and more specifically to systems for identifying vehicles by photographing license plates.

### BACKGROUND ART

There are many situations where it is desirable to be able to identify the vehicles which pass over particular portions of roadways, driveways and the like. Identification can be valuable for security purposes (such as entering, or leaving secure areas, parking garages and the like), for apprehension of scofflaws, such as on toll bridges and toll ways, and for crime prevention and incident resolution.

One of best ways to identify vehicles is by the use of license plate photographs. Various methods have been used in the past to photograph vehicles at various stages, with the intent of obtaining positive identifications. Pole and overhead mounted systems often provide poor angles of incidence. Especially during night conditions, glare, vehicle lights and fog lamps interfere with the camera's image capture, and therefore require sophisticated light filtering devices. Unfortunately, camera angles and weather and lighting conditions often conspire to obscure the license plates of the vehicles and make the identification difficult or impossible in many cases.

Accordingly, a continuing need exists to provide a system for obtaining usable quality vehicular license plate photography. In addition, there is a need for economical systems for providing identification images which capture readable license plates.

### DISCLOSURE OF INVENTION

Accordingly, it is an object of the present invention to provide an in situ license plate photography system which is easy to use and inexpensive.

Another object of the invention is to provide a durable mounting and support system for a camera to photograph license plates of vehicles.

Yet another object of the invention is to provide an unobtrusive security device for surveillance photography of vehicles passing above the mounting location.

Still another object of the invention is to provide an easily installed, maintained and removed surveillance system for license plate photography.

A further object of the invention is to provide a speed bump visual (and tactile) appearance which urges drivers to slow the vehicle speed sufficiently that good visual images of license plates can be captured.

Briefly, one preferred embodiment of the present invention is a system for mounting visual surveillance equipment such as CCD (CCTV) camera elements in a “speed bump” secured to a driving surface. The speed bump is similar to normal traffic control structures and is secured to the surface of a driveway or street in a location where surveillance of the traffic is desirable. The speed bump is constructed of at least partially resilient materials to minimize shock and vibrational damage from the passage of vehicles. External control circuitry is connected to the internal camera elements.

The preferred speed bump camera mounting system includes an elongated component with a semi-elliptical cross section which is secured to a driving surface. The elongated element includes a pair of opposed cameras containing holes situated near the center, each being angled to provide good aspect aiming for capturing images of license plates of approaching and receding vehicles, respectively. Axial grooves on the bottom surface provide access for electronic wiring as well as drainage for the camera apertures. The preferred embodiment further includes striping and reflectors to enhance visibility and warn approaching drivers of the speed bump.

An alternate embodiment utilizes a more compact alternate camera having a thread screw extending from the rear of the camera. The alternate camera is secured within the image tube by a washer and nut arrangement which may be tightened to hold the structure securely against the inner surface of the axial groove.

An advantage of the present invention is that the mounting of the camera element at road surface level provides optimum camera angles for photographing license plates.

Another advantage of the present invention is that embedding the camera elements within a speed bump provides an unobtrusive surveillance location.

Still another advantage of the present invention is that the system is adapted to be quickly and removably mounted on a driving surface, making it suitable for use in temporary surveillance situations.

A further advantage of the present invention is that the speed bump components of the system can be inexpensively manufactured so that the system is broadly usable.

Yet another advantage of the present invention is that the speed bump mounted license plate camera system captures either or both front and rear license plate images, thus increasing the probability of positive identification.

Still another advantage of the present invention is that it psychologically induces drivers to position the vehicle in perfect position for good image capture of license plates.

These and other objects and advantages of the present invention will become clear to those skilled in the art in view of the description of the best presently known modes of carrying out the invention and the industrial applicability of the preferred embodiments as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 is a perspective view of a speed bump mounted license plate camera system shown as installed upon a typical driving surface;

FIG. 2 is a stylized top elevational view of the mounting system (speed bump) of the present invention;

FIG. 3 is a cross sectional view (taken along line 3-3 of FIG. 2); and

FIG. 4 is a cross sectional view similar to that of FIG. 3 showing an alternate embodiment.

### BEST MODE FOR CARRYING OUT THE INVENTION

A preferred embodiment of the present invention is a speed bump mounted license plate camera system adapted to be placed on a driving surface and used for vehicle surveillance and identification. As illustrated in the various drawings herein, the preferred embodiment of the inventive system is designated by the general reference character 10.

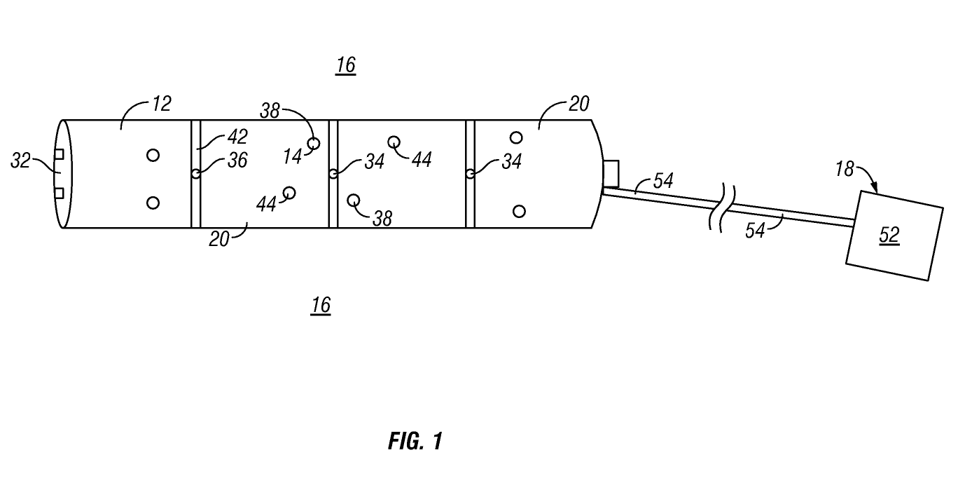

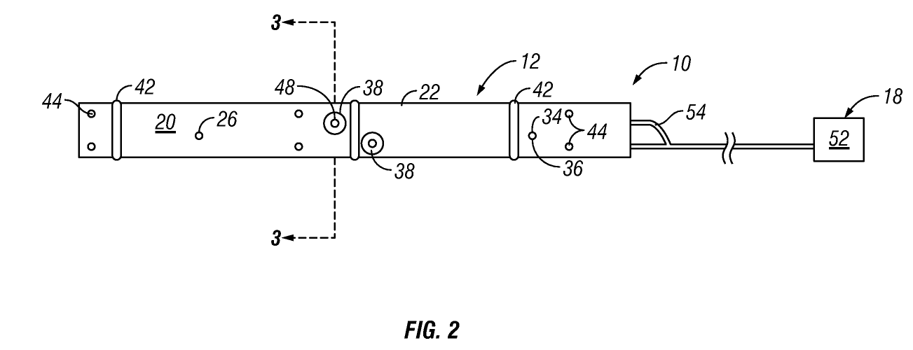

As illustrated in the views of FIGS. 1, 2 and 3, the preferred speed bump mounted license plate camera system (system) 10 includes a mounting subsystem 12 (speed bump) which supports and encloses an image subsystem 14 adapted to capture images. The speed bump 12 and the incorporated image subsystem 14 are adapted to be installed on a driving surface 16, such as a driveway or street. An external control subsystem 18 controls the operation of the image subsystem and records the images captured thereby.

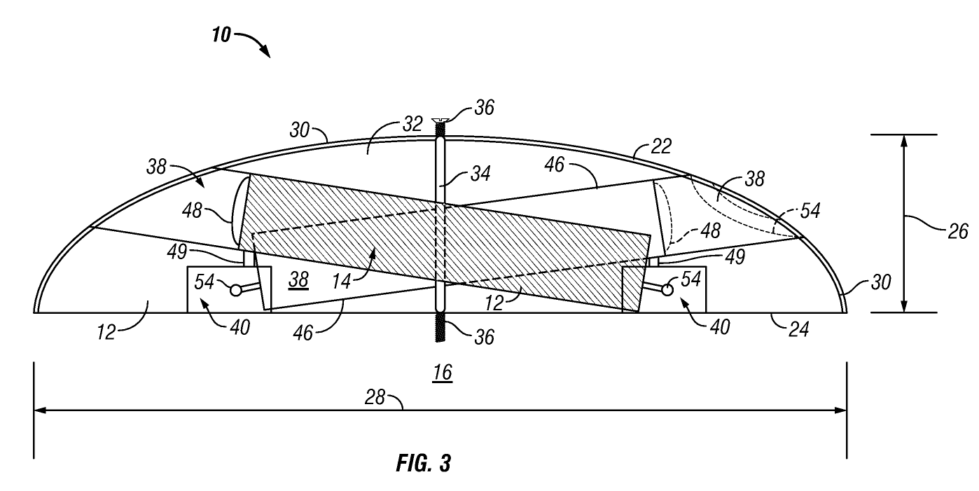

The principal structure of the invention is provided by the speed bump 12 component which comprises the mounting subsystem. As seen in each of the figures of the drawing, the speed bump 12 is an elongated member 20 having a semi-elliptical cross section (see FIG. 3) with a curved upper surface 22 and a planar lower surface 24 for abutting against the driving surface 16. The speed bump elongated member 20 has a vertical thickness 26 which is maximal at the center axis and a horizontal thickness 28. The preferred elongated member 20 is generally bilaterally symmetrical about a longitudinal axial plane and a bisecting perpendicular plane.

As seen in the cross sectional view of FIG. 3 the elongated member 20 of the preferred embodiment is provided with a resilient outer surface layer 30 and a more rigid interior structural layer 32. The resilient surface layer 30 serves to provide cushioning against vibrational shocks to the image subsystem 14 and also helps to prevent fracturing of the material during the heavy usage, which includes large vehicles traveling over the speed bump, often at greater than optimal speeds. The denser interior structural layer 32 is more rigid, but still somewhat resilient, and provides sufficient protection for the image subsystem components.

The elongated member is provided with a plurality of axially spaced mounting apertures 34 which allow the insertion of bolts or screws 36 which may be inserted therethrough to engage the driving surface 16 and secure the speed bump 12 in place on the driving surface 16. In the preferred embodiment three such mounting apertures are provided, with each being at the axis for extending through the maximum vertical thickness 26 and providing the greatest support. Anchored lag bolts are the preferred bolts 36 used to provide good anchoring with minimal disruption to the road surface 16.

A pair of image tubes 38 are closely spaced on either side of the perpendicular plane, with one facing each direction. These are angled upward form the driving surface at about twenty degrees (20°) to provide optimal camera angles for photographing license plates on approaching and receding vehicles respectively.

A pair of elongated axial grooves 40 (see FIG. 3) are provided in the lower surface 24 and extend the length of the elongated member 20. The grooves 40 provide access from the ends of the speed bump 12 to the image in order to permit interconnection of the image subsystem 14 and the control subsystem 18. The grooves 40 also allow drainage of the image tubes 38 to prevent the build up or precipitation water, etc. which could obscure the image quality.

The upper surface 22 of the speed bump 12 is provided with a pair of broad yellow Hypalon stripes 42 and six axially and radially spaced cat eye reflectors 44 to facilitate visuals for approaching drivers. It is noted that most drivers seek to avoid actually driving over the speed bump 12 member itself. Therefore, the total length of the elongated member 20 is selected to be less than the typical wheel base separation of vehicles and is less than most speed bumps used for traffic calming purposes. The stripes 42 and reflectors 44 also help to visually align the speed bump 12 in the driver's mind so the vehicles are usually well centered for license plate photography.

The image subsystem 14 primarily includes a pair of matched cameras 46, each of which includes a focusing camera lens 48 to capture the images. These are mounted within the image tube 38 such that the camera lens 48 is situated significantly within the image tube 38 and in the interior of the speed bump 12. The portion of the image tube 38 in front of the camera lens 48 serves to provide physical protection of the camera 46 against breakage. This also provides a barrier against ambient light which may come to the camera 46 from directions other than the intended angle. The camera may be mounted snugly in the image tube 38 and a drain hole 49 is provided just outward of the camera lens 48 to connect the image tube 38 to the axial groove 40 and facilitate draining water from in front of the camera lens 48. Alternatively, the camera 46 may not be mounted so as to be completely flush with the interior of the image tube 38 such that rainwater and the like may drain past the camera lens 48 and out through the axial groove 40, rather than building up and obscuring the focus of the camera lens 48.

An optional protective lens 50 may be mounted in the image tube 36 to prevent objects or the like from damaging or obscuring the view, but this is not present in the preferred embodiment because of the difficulty in preventing breakage and the potential interference of the protective lens 50 with image quality.

Each camera 46 is typically powered by a battery array 52 which is typically situated remotely from the camera, since the power and size parameters do not permit local battery power with current technology. The power, control and video are carried by control wiring 54 connecting the camera with the remote control subsystem 18. The wiring extends from the camera through the axial groove 40. The wiring 54 is provided with shrink tube protection against abrasion, crushing and moisture damage. It will typically be secured within the axial groove 40 by a series of wire clips or staples to keep it above the driving surface 16.

The preferred embodiment 10 includes a pair of matched cameras 46 in order to function to capture images of both the front and rear plates of vehicles passing over the speed bump 12. It is certainly possible to implement the system 10 with a single camera only, but this is not considered optimum, since obstacles may obscure one or the other of the plates.

Depending on the composition of the control subsystem 18, each camera 46 may be adapted to provide continuous video feed or may be triggered by a remote pressure sensor or similar triggering mechanism for capture of discrete images. Continuous digital video recording is preferred. The precise composition and use of the control subsystem 18 will be up to the particular user and may be adapted to the particular purpose, but will typically include a digital video recorder to record the captured images.

In the preferred embodiment 10 of the invention the elongated member 20 is constructed to have a length of 120 cm (48 inches), a horizontal width 28 of 30 cm (12 inches) and a vertical thickness 26 of 6.6 cm (2⅝ inches). The three mounting apertures 34 are spaced to be 40 cm (18 inches) apart with one being situated at the center of the elongated member 20. The axial grooves 40 have a square cross section of 3.1 cm (¼ inch).

The image tubes 38 extend through the body of the elongated member 20 at an angle of twenty degrees (20°) and emerge from the upper surface 22 at about the midpoint of the curve. Each image tube 38 has its bottom terminus at the associated axial grove 40 on the opposite side of the axis of the elongated member 20. Each image tube 38 has a diameter of 2.8 cm (1⅛ inch).

The preferred material of the elongated member 20 is recycled rubber for the interior structural layer 32 while the resilient surface layer 30 is formed of virgin rubber and has a thickness of about 0.3 cm (⅛ inch).

The preferred image capturing camera 46 is a 0.6 cm (¼ inch) Color CCD image sensor, capable of resolving 512×491 pixels (NCSC) or 512×581 pixels (PAL). The resolution is 350 TV lines and minimum illumination is 1 Lux/F2.0. The signal to noise ratio is selected to be greater than 48 db (AGC off) with an electronic shutter adjustable between 1/60 to 1/100,000 second. The selected camera 46 is adapted to function over a wide temperature range with low lag and high burn resistance.

Preferably a remote 12 Volt DC battery array 52 (or a 12 Volt Power supply or AC/DC converter) is provided with the power being delivered to the camera 46 via the wiring 54. Control commands are delivered to the camera and captured images are carried by the wiring 54 from the camera to the control subsystem 18 where the images are typically digitally recorded and stored (or transmitted to remote storage and analysis facilities). The digitally recorded images may later be converted to still photographs as required.

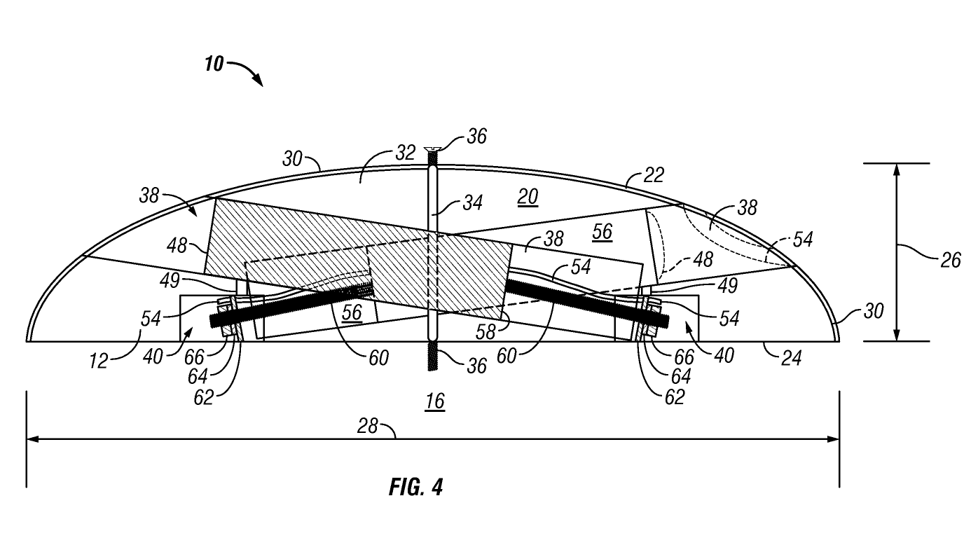

A first alternate embodiment 10′ of the present invention is illustrated in the cross sectional view of FIG. 4. This embodiment utilizes an alternate image subsystem 14′ including an alternate camera 56. The alternate camera 56 is a weatherproof bullet camera, being a CCD camera with a 6 mm lens. It is a Sony Color ⅓ Super HAD device with Hi-Resolution color and 480 lines and 0.2 Lux. The alternate camera 56 is characterized by having auto gain control and auto white balance along with wide dynamic range working power tolerance. In addition, the alternate camera 56 has built-in features including surge voltage input protection and reverse polarity input protection. The alternate camera 56 is further characterized as having low power consumption and uses 130 mAmp operating current.

The alternate camera 56 is also mounted in a slightly different manner in order to secure it within the image tube 38. The rear camera end 58 (opposite the lens 48) is bonded to a threaded shaft 60 as shown in FIG. 4 (either by adhesion or by a threaded connector in the alternate camera 56 itself). The threaded shaft 60 extends downward through the image tube 38 and into the transverse axial groove 40. A slotted washer 62 is placed over the threaded shaft 60 so that it abuts against the edge of the surface of the axial groove 40. The slotted washer 62 includes a slot to allow the wiring to pass through it without cramping. A smaller diameter standard washer 64 is then added (with the wring 54 extending past the circumferential edge thereof) to hold the slotted washer 62 in position. Finally, a nut 66 is tightened on the threaded shaft to hold the alternate camera 56 firmly in position within the image tube 38.

The dimensions for the first alternate embodiment 10′ are slightly different in that the alternate camera 56 is shorter than the camera 46. The alternate camera 56 is 4.5 cm (3 inches) long and 1.9 cm (¾ inch) in diameter. The threaded shaft 60 is #20 (¼ inch) stainless steel and extends 5 cm (2 inches) beyond the rear camera end 58. The slotted washer 62 has a diameter of 2.5 cm (1 inch) and has a 0.63 cm (¼ inch) slot extending to the center bore. The standard washer 64 is a 1.3 cm (½ inch) washer and the nut 66 is a standard #20 (¼ inch) threaded nut.

The dimensions, materials and precise components set forth above are exemplary only and are not intended as limiting the scope of the invention.

A further alternative embodiment to the preferred speed bump system 10 would be to mount the camera within the road surface itself (again angled to optimally capture the license plate images). This is not preferred because of damage to the driving surface, increased susceptibility to breakage and lack of portability.

Although the preferred embodiment is in the form of an elongated speed bump, the particular shape is not critical. A domelike disk member could also be utilized if properly centered on the roadway, as could components disguised as reflectors. The speed bump design is preferred because of ease of alignment, durability and commonplace usage.

While various embodiments have been described above, it should be understood that they have been presented by way of example only, and not as limitations.

### INDUSTRIAL APPLICABILITY

The present invention is adapted for use in surveillance and monitoring circumstances where it is desirable to record license plate images for use in vehicle tracking and identification. Typical uses may be at toll facilities, security garages, workplaces, cargo container gates, and vehicle drive through lanes where vehicular tracking is desired. The system is adapted for use by professionals and others and is simple enough in implementation and installation that many users will be able to make use of it.

In a typical installation a user will select a portion of a driving surface 16 where monitoring is desired. The user will then place the elongated member 20 across the driving surface 16 to lie perpendicularly to the direction of travel. The speed bump 12 is optimally centered in the lane so that most drivers will attempt to straddle rather than engage the bump. This both reduces wear and damage to the components and centers the cameras 46 on the license plates of the vehicles. Anchoring bolts or screws 36 are then placed through the mounting apertures 34 and driven or screwed into the driving surface to hold the speed bump in place.

The control subsystem 18 and the battery array/power supply 52 will typically be mounted at a location off of the driving surface (and preferably out of view) and will be connected to the image subsystem 14 through the wiring 54. Typically, installation and set up of the system can be accomplished in forty-five minutes or less.

Once in place the system may be remotely monitored. Periodic maintenance may be required to clear debris out of the image tubes 38 and to otherwise maintain alignment. Camera units may be replaced as necessary but the system should ordinarily be usable without significant maintenance for a period of weeks or months.

The simplicity of installation, relatively low cost of materials and components, and improved location of image capture components make the present invention particularly optimal for any circumstance where monitoring of vehicular license plates is desirable.

For the above, and other, reasons, it is expected that the speed bump mounted license plate camera system of the present invention will have widespread industrial applicability. Therefore, it is expected that the commercial utility of the present invention will be extensive and long lasting.

1. An image capture system adapted for use on a driving surface, comprising:
a member secured against the driving surface; and
at least one image capture member mounted within said member and angled upward to be aimed at typical license plate locations on vehicles passing over the system.

2. The image capture system of claim 1, wherein
said member is an elongated speed bump having a semi-elliptical cross section.

3. The image capture system of claim 2, wherein
said image capture member is a camera mounted within an image tube formed within said speed bump.

4. The image capture system of claim 2, wherein
said speed bump has a resilient surface layer and an interior structural layer.

5. The image capture system of claim 2, wherein
said speed bump is provided with at least one axial groove on its undersurface in order to facilitate receiving wiring extending to and from said image capture member.

6. The image capture system of claim 2, wherein
said speed bump is provided with reflectors and/or stripes in order to facilitate visual recognition and centering by approaching drivers.

7. The image capture system of claim 2, wherein
said speed bump includes at least one angled image tube extending from the upper surface to an axial groove on the undersurface;
said image capture device is a CCD video camera placed within said image tube with a lens outwardly aimed;
a threaded shaft extends from the rear of said camera into said axial groove, at least one washer is placed over said threaded shaft to abut against the axial groove and hold said camera in place and a nut is placed on said threaded shaft to secure said washer.

8. The image capture system of claim 7, wherein
said at least one washer includes a slotted washer and a standard washer having a smaller diameter than said slotted washer.

9. A speed-bump mounted license plate camera system, comprising
an elongated speed bump for transverse mounting on a vehicle driving lane, said speed bump having an upper surface and a lower surface for abutting against the driving lane, and at least one image tube near the longitudinal center thereof, said image tube being angled to be optimally aimed at license plates of approaching or receding vehicles passing over said speed bump; and
an image capture device mounted within said image tube for photographing license plates.

10. The speed-bump mounted license plate camera system of claim 9, wherein
said speed bump is provided with reflectors and/or stripes in order to facilitate visual recognition and centering by approaching drivers.

11. The speed-bump mounted license plate camera system of claim 9, wherein
each said image tube is angled at approximately 20 degrees from horizontal.

12. The speed-bump mounted license plate camera system of claim 9, wherein
said speed bump is provided two of said image tubes each containing one of said cameras, with said two image tubes being arrayed in opposite directions to capture, respectively, approaching and receding license plate images.

13. The speed-bump mounted license plate camera system of claim 9, wherein
said speed bump is provided with at least one axial groove and the lower end of said image tube intersects said axial groove such that wiring may run from said image capture device through said axial groove to externally situated power and recording hardware.

14. The speed-bump mounted license plate camera system of claim 9, wherein
said image capture device is a CCD video camera placed within said image tube with a lens outwardly aimed; and
a threaded shaft extends from the rear of said camera into said axial groove, at least one washer is placed over said threaded shaft to abut against the axial groove and hold said camera in place and a nut is placed on said threaded shaft to secure said washer.

15. A license plate photography system, comprising
a continuously operating image capture device adapted to photograph license plates of vehicles traveling on a driving surface; and
a mounting component for holding said image capture device in proximity to said driving surface and at an angle to capture license plate images.

16. The license plate photography system of claim 15, wherein
said mounting component is an elongated member having a semi-elliptical cross section transversely secured to said driving surface in a location approximately centered under the expected travel pathway of vehicles; and
an image tube is formed in said elongated member to contain said image capture device therewithin, said image tube being angled from said driving surface and located near the longitudinal center of said elongated member so as to provide optimal photographic access to license plates.

17. The license plate photography system of claim 16, wherein
said mounting component is in the form of a speed bump.
